(19) United States
(12) Patent Application Publication
(10) Pub. No.: US 2021/0374648 A1
(43) Pub. Date: Dec. 2, 2021

(54) SYSTEM AND METHOD FOR REMOTE MONITORING OF EVALUATOR PERFORMING ONSCREEN EVALUATION OF ANSWER SHEETS

(71) Applicant: SPLASHGAIN TECHNOLOGY SOLUTIONS PVT. LTD, Pune (IN)

(72) Inventors: Samir Kamat, Pune (IN); Swapnil Dharmadhikari, Pune (IN)

(73) Assignee: SPLASHGAIN TECHNOLOGY SOLUTIONS PVT. LTD, Pune (IN)

(21) Appl. No.: 17/288,348

(22) PCT Filed: Oct. 24, 2019
(86) PCT No.: PCT/IN2019/050781

§ 371 Date: Apr. 23, 2021

(30) Foreign Application Priority Data
Oct. 26, 2018 (IN) 201821040430

(51) Int. Cl. G06Q 10/06; G06Q 30/00; H04L 29/06; G06F 16/587

(52) U.S. Cl. CPC G06Q 10/06398; G06Q 30/018; G06Q 50/205; G06F 16/587; H04L 63/0838

(57) ABSTRACT

Present invention relates to field of comprehensive examination management system and particularly provides a system (100) and method (200) adapted to monitor an examiner/evaluator performing onscreen evaluation of the answer sheets. The system (100) comprises of a computing device (10), a communication network (20), a centralized web server (60) and a centralized database (70). The method (200) is divided into three tasks including scanning (120) of the answer sheets, remote monitoring of the evaluator (140) by an invigilator and onscreen evaluation by the evaluator (160) from a remote location using an onscreen evaluation platform (150). The method (200) offers continuous monitoring of the evaluator and addresses security and integrity issues involved during use of the onscreen evaluation platform (150) and at the same time facilitating compilation of end results within shorter span of time.

### RELATED APPLICATIONS

This is a United States National Stage Patent Application that relies for and claims priority to International Patent Application No. PCT/IN2019/050781, filed on Oct. 24, 2019, and Indian Patent Application No. 201821040430, filed on Oct. 26, 2018, the entire contents of both of which are incorporated herein by reference.

### FIELD OF INVENTION

The present invention relates to a field of comprehensive examination management system including onscreen evaluation of answer sheets, and more particularly provides a system and method adapted to monitor an examiner/evaluator performing onscreen evaluation of the answer sheets.

### BACKGROUND OF THE INVENTION

Existing answer sheet evaluation process requires the examiners/evaluators to travel to a central secure location (for example: a university hub) to complete the process of checking physical copies of answer sheets. Traditionally used method of answer sheet evaluation involves the following activities to be performed in order to declare result:

1. Collection of physical answer sheets at a central secure location from multiple examination centers across multiple locations;

2. Masking of student's identity from the answer sheets;

3. Inviting examiners at the central secure location to evaluate the masked answer sheets: this also involves arranging logistics and travel cost. Lack of analytics makes it difficult to track progress of each examiner;

4. Manually calculating the total marks obtained by each candidate: which is a time-consuming process; and

5. Manual entry of marks by the examiner for each candidate.

Thus, the traditional evaluation process involves a lot of physical answer sheet handling, and other administrative and logical activities. Further, it requires lot of storage space to maintain and manage large volumes of physical answer sheets and making scan photocopies available to candidate when requested becomes a tedious job. Further, the process of rechecking, moderation, secure storage of the answer sheet, audit and result compilation adds to complexity of the process. In addition, the evaluator cannot evaluate the answer sheets from his residence since it raises concerns regarding security of documents (fear of misplacing the physical answer sheets in transmit mode), and quality of the evaluation (evaluator might assign the work to other incompetent authority).

Existing systems eliminate the need of such traditional process of evaluation by providing an onscreen evaluation platform through which the examiners can evaluate the answer sheets across any locations without travelling to the central secure hub. Onscreen evaluation system eliminates process of physical handling of answer sheets and helps user to evaluate answer sheets using online software. The onscreen evaluation platform can be enabled on certain IP addresses so that examiners can check answer sheets from their home/institute. However, the onscreen evaluation platform faces the following shortcomings:

1. Requires the examiner to travel to university or any other secure central hub during evaluation to prevent fraudulent practices by the evaluator such as assigning the work to some other third party thereby affecting quality of evaluation and integrity of data;

2. Evaluations performed across multiple locations (such as home, public location etc.) raises concerns regarding security and quality since the examiner might assign the evaluation work to other third party thereby compromising on the quality of evaluation; and

3. No control on the quality and outcome of overall evaluation process by the University.

Both the traditional and the onscreen evaluation systems face concerns regarding quality and data integrity, and hence require the evaluator/examiner to travel down to the central hub to address the afore-mentioned issues. Hence, today travelling to a central location seems to be a bottleneck resulting in delay in overall answer sheet evaluation process.

Therefore, there is a need to provide a system and a method that addresses the shortcomings of the afore-mentioned conventionally used evaluation systems. There is a need for a system addressing security and integrity issues involved during use of the onscreen evaluation platform, and at the same time compiling end results within shorter span of time.

It is an object of the present invention to provide an individual remote monitoring system and method therefor.

It is another object of the present invention to provide an individual remote monitoring system facilitating remote monitoring of an examiner/evaluator performing online evaluations of answer sheets.

It is yet another object of the present invention is to address security and integrity issues involved during use of the onscreen evaluation platform.

### SUMMARY OF THE INVENTION

Accordingly, in one aspect, the present invention provides a system for monitoring an evaluator performing onscreen evaluation of answer sheets. The system comprises of a computing device, a communication network, a centralized web server and a centralized database that are in operable communication with each other. The system also has a scanning apparatus to scan copies of the answer sheets. The centralized web server is configured with a web application for remotely monitoring the evaluator accessing the onscreen evaluation platform. The web application comprises of, but not limiting thereto, at least one acquisition module, at least one database module, at least one authentication module, and all other components typically associated therewith. The afore-mentioned components are operably associated with each other. Particularly, the system is operably coupled to the onscreen evaluation platform over a communication network for monitoring the evaluator who is remotely accessing the onscreen evaluation platform using a computing device to evaluate the answer sheets online from a remote location. The onscreen evaluation platform provides a control panel to the evaluator to open scanned copy of the answer sheet, and thereafter perform evaluation using annotation tools known in the art. The onscreen evaluation platform is further adapted to automatically calculate total scoring of the candidate based on the evaluation performed by the evaluator and maintain activity logs of the evaluator.

In another aspect, the present invention provides a method for monitoring of the evaluator performing onscreen evaluation of the answer sheets. The method is divided into three tasks including scanning activity for scanning the answer sheets by the scanning apparatus, monitoring of the evaluator during the online evaluation activity by an invigilator/administrator and onscreen evaluation by the evaluator/examiner. The method facilitates the administrator to keep track of the progress of the evaluation activity for each evaluator of the plurality of evaluator differently located at remote locations thereby achieving evaluation within a certain timeframe. The method is adapted to monitor and closely watch the evaluator and to send alerts to the administrator in event of detection of suspicious activity (for ex. two faces detected, different evaluator detected compared to the registered evaluator). In addition, the method facilitates the administrator to keep track of the progress of the evaluation activity for each evaluator of the plurality of evaluator differently located at remote locations thereby achieving evaluation within a certain timeframe.

### BRIEF DESCRIPTION OF DRAWINGS

The objects and advantages of the present invention will become apparent when the disclosure is read in conjunction with the accompanying figures. These figures are intended to be illustrative, not limiting. Although the invention is generally described in the context of these embodiments, it should be understood that it is not intended to limit the scope of the invention to these particular embodiments.

FIG. 1 shows a block diagram of a system for monitoring an evaluator performing onscreen evaluation of answer sheets, in accordance with the present invention;

FIG. 2-FIG. 6 illustrate various flow charts illustrating a method for monitoring the evaluator performing onscreen evaluation of the answer sheets, in accordance with the present invention; and

FIG. 7 illustrates an illustrative representation of an onscreen evaluation platform used by the evaluator for evaluation of the answer sheets, in accordance with the present invention.

### DETAILED DESCRIPTION OF THE INVENTION

The foregoing objects of the present invention are accomplished and the problems and shortcomings associated with the prior art, techniques and approaches are overcome by the present invention as described below in the preferred embodiments.

The present invention provides a system and method for monitoring an evaluator performing onscreen evaluation of answer sheets. The system is operably coupled to the onscreen evaluation platform over a communication network for monitoring the evaluator who is remotely accessing the onscreen evaluation platform using a computing device to evaluate the answer sheets online from a remote location. The method facilitates an administrator to keep track of the progress of the evaluation activity for each evaluator of the plurality of evaluator differently located at remote locations thereby achieving evaluation within a certain timeframe.

The present invention is illustrated with reference to the accompanying drawings, throughout which reference numbers indicate corresponding parts in the various figures. These reference numbers are shown in bracket in the following description.

The present invention provides an individual remote monitoring system and method therefor. The features, functionalities, components, conditions of operation and steps of the system and the method of the present invention include but are not limited to the disclosure provided herein below.

In accordance with the present invention, an individual remote monitoring system (hereinafter referred to as “the system”) and an individual remote monitoring method (hereinafter referred to as “the method”) is disclosed. The system and the method facilitate remote monitoring of the individual. For purpose of the present disclosure, the term “individual” refers to, not limiting thereto, a candidate, an invigilator, an examiner, an evaluator and like personnel. In one non-limiting example embodiment, the system and the method facilitate remote monitoring of the candidate appearing for examination/online test. The system and the method facilitate constant monitoring of the candidates to prevent the candidates from engaging in variety of activities which may compromise the test integrity, including but not limiting to, copying answers, sending or receiving messages, accessing websites and like, during online examination process.

In a preferred embodiment of the present invention, the system and the method facilitate real-time remote monitoring of the examiner/evaluator. For purpose of the present disclosure, the term “examiner/evaluator/moderator” refers to, not limiting to, personnel involved in assessment/evaluation/checking of the answer sheets/papers. More specifically, the system and the method facilitate real-time remote monitoring of the evaluator who is using an onscreen/online evaluation platform to perform assessment of the answer sheets. Particularly, the system is operably coupled to the onscreen evaluation platform over a communication network for monitoring the evaluator who is remotely accessing the onscreen evaluation platform using a computing device to evaluate the answer sheets online from a remote location. The onscreen evaluation platform provides a control panel to the evaluator to open scanned copy of the answer sheet, and thereafter perform evaluation using annotation tools known in the art. The onscreen evaluation platform is further adapted to automatically calculate total scoring of the candidate based on the evaluation performed by the evaluator and maintain activity logs of the evaluator.

Referring to FIG. 1, a system for remote monitoring (100) of an evaluator performing onscreen evaluation of the answer sheets (hereinafter referred as, “the system (100)”), in accordance with the present invention is disclosed. The system (100) comprises of a computing device (10), a communication network (20), a centralized web server (60) and a centralized database (70). The system (100) further comprises a scanning apparatus (not shown) to scan copies of the answer sheets.

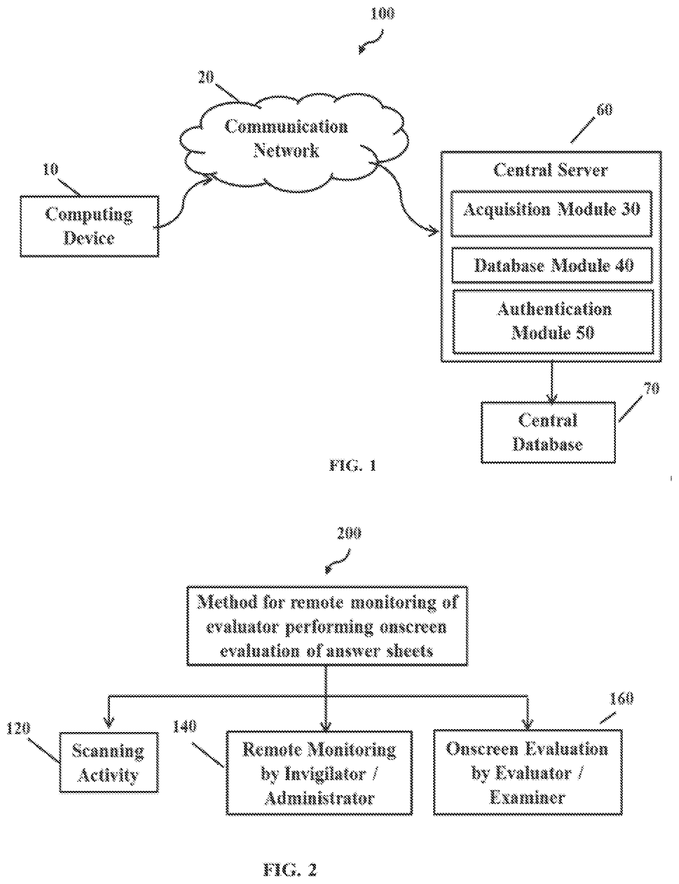

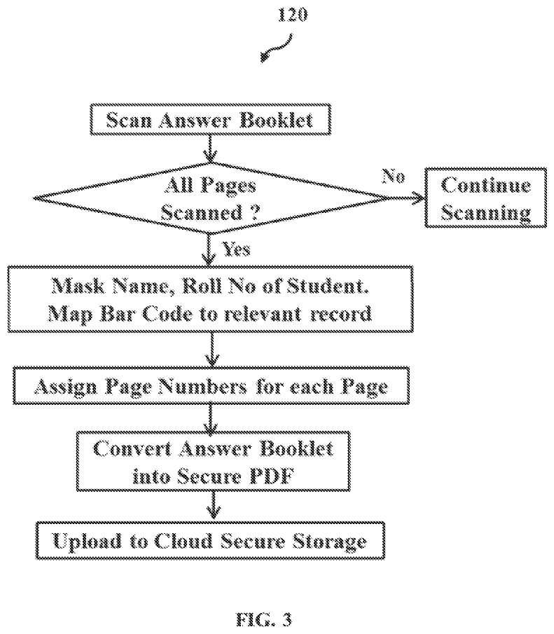

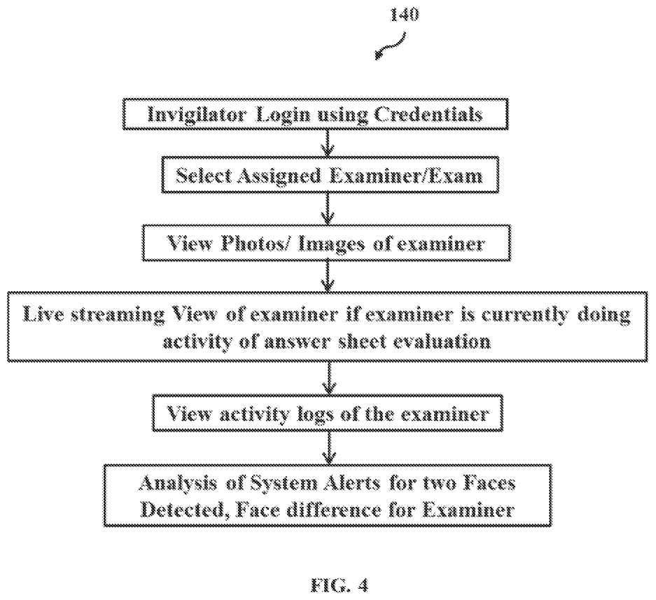

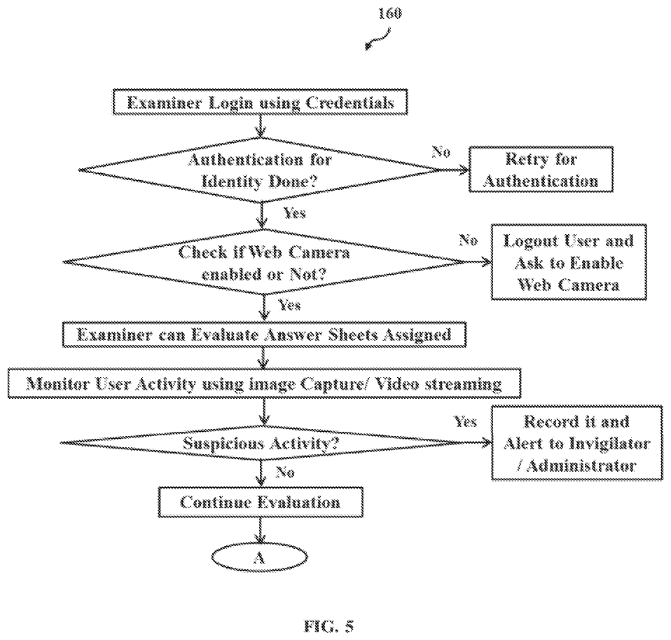

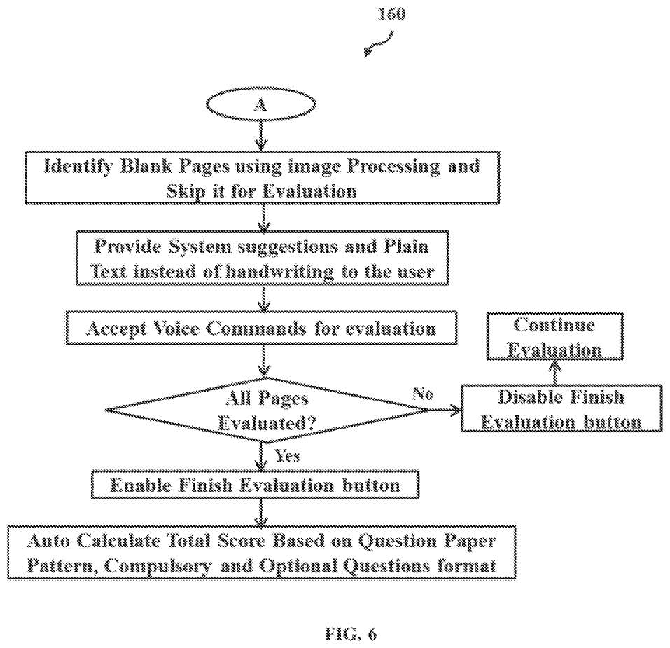

Now, referring to FIG. 2-FIG. 7, a method for remote monitoring (200) of the evaluator performing onscreen evaluation of the answer sheets (hereinafter referred as, “the method (200)”), in accordance with the present invention is described. The method (200) is described in conjunction with the system (100). The method (200) is divided into three tasks including scanning activity (120) (Ref. FIG. 3) for scanning the answer sheets by the scanning apparatus, monitoring of the evaluator (140) during the online evaluation activity by an invigilator/administrator (Ref. FIG. 4) and onscreen evaluation by the evaluator/examiner (160) (Ref. FIG. 5 and FIG. 6).

The computing device (10) consisting of at least one memory unit (not shown) being capable of storing a plurality of processing instructions for an operation of the computing device (10), at least one processor (not shown) being capable of communicating with the memory unit and at least one input-output device (not shown) operably coupled thereto. The processor is configured to issue the plurality of processing instructions stored in the memory unit. The input-output device includes, but is not limited thereto, a keyboard and a mouse for the evaluator to input a command/a message, a microphone for acquiring voice of the evaluator, a loudspeaker for outputting the voice, a web camera for acquiring an image/a video of the evaluator and a display unit for displaying the outcome of the imaging device. For purpose of the present disclosure, the “computing device (10)” includes, but is not limited thereto, computer, laptop, desktop, smartphone, mobile, cell phone, Personal Digital Assistant (PDA), tablet and like devices known in the art.

The communication network (20) is adapted for communicating with the computing device (10). For purpose of the present disclosure, the communication network (20) refers to but is not limited to, local area network, wide area networks, Bluetooth network, aggregated networks such as the internet and cloud-based computer network. In an embodiment, the communication network can be any one of a wired and a wireless communication network including, but not limiting to, an Internet.

The centralized web server (60) is adapted for processing the instructions received from the communication network (20). The centralized web server (60) is configured with a web application (not shown) for remotely monitoring the evaluator accessing the onscreen evaluation platform (150) (Ref. FIG. 5). The web application comprises of, but not limiting thereto, at least one acquisition module (30), at least one database module (40), at least one authentication module (50), and all other components typically associated therewith. The afore-mentioned components are operably associated with each other.

The centralized database (70) is adapted for generating a corresponding output related to processed instructions received from the centralized web server (60) and delivering the output to the computing device (10), wherein the centralized database (70) stores scanned copies of the answer sheets.

The system (100) and the method (200) facilitate constant monitoring of the evaluator during the online evaluation activity (140) (Ref. FIG. 4). Specifically, when the evaluator tries to remotely access the onscreen evaluation platform (150) using login credentials, the method (200) intervenes to validate the identity/credentials of the evaluator and to verify if the computing device (10) used by the evaluator satisfies certain pre-set hardware configuration requirements before allowing communication and access to the onscreen evaluation platform (150).

The acquisition module (30) associates and controls a web camera and audio-video system of the computing device (10) which is used by the evaluator for accessing the onscreen evaluation platform (150). The acquisition module (30) is adapted to continuously monitor the evaluator over the communication network (20) by performing continuous activity of photo capturing, audio/video recording as well as streaming of user (in this case examiner/evaluator) onscreen evaluation activity. In an embodiment, in the event the system (100) is used to monitor the candidate appearing for examination and is operably coupled to the computing device of the candidate, the acquisition module (30) monitors and captures photo, audio/video streaming of the candidate giving the examination. The acquisition module (30) captures images and audio/video streaming of the individual who is being monitored for the plurality of activities. In an embodiment, speed of the streaming activity and the photo capturing frequency is adjusted according to speed of the communication network (20) (for example: speed of internet connection). Particularly, the system (100) is adapted to change frame rate or image capturing frequency depending upon the internet speed at the evaluator's location.

The acquisition module (30) captures photograph of the evaluator by controlling and using the web camera of the computing device (10) used by the evaluator. Particularly, when the evaluator logs into the onscreen evaluation platform (150) using the computing device (10), the system (100) intervenes and captures photograph of the evaluator using the web camera attached to the computing device (10). In the event the computing device (10) used by the evaluator lacks pre-set hardware configuration including the web camera, or in the event the web camera is not detected by the system, the system (100) prevents/blocks the evaluator from accessing the onscreen evaluation platform (150) for evaluations of the answer sheets. In the event, the photograph of the evaluator is captured and acquired by the acquisition module, the system (100) allows the evaluator to proceed further and access the onscreen evaluation platform (150) for evaluation of the answer sheets. The acquisition module (30) further activates and initiates video streaming of the examiner/evaluator who is evaluating the answer sheets using the onscreen evaluation platform (150). The acquisition module (30) is further adapted to generate geotags for the photographs acquired using the web camera. Geotagging enables tagging the photographs of the evaluator with geographical information of the evaluator, the information including, but not limited to, city name, pin code, and address details. The geotagged information finds use during auditing process. In short, the evaluator is continuously monitored by the system (100) to ensure authentication and authorization thereof during ongoing process of evaluation of the answer sheets. The acquisition module (30) further captures screen activity of the evaluator while the evaluator performs evaluation of the answer sheets. Furthermore, live screening/broadcasting of the evaluator along with historical activities is also facilitated by the system of the present invention, thereby finding use during auditing process. In addition to the video streaming, the acquisition module (30) of the system (100) also records entire evaluation activity of the evaluator, for auditing purposes.

The database module (40) is adapted to store credentials of the evaluator initially registered within the system. The database module (40) also maintains the captured photographs/images of the evaluator taken at different intervals of time by the acquisition module (30) along with audio-video streaming of the evaluator. Data, including but not limited to, the plurality of photographs (captured at varied time intervals), the audio-video streaming and the historical videos of the evaluator, remains stored within the database module (40) for each evaluator and can be accessed/viewed at a later stage, if required, for auditing and like purposes.

The authentication module (50) performs two step remote authentications. At first step, the authentication module (50) performs an identity check to validate the evaluator based on combination of parameters and techniques, including but not limited to, One Time Password (OTP) authentication, face detection and identity card based authentication including AADHAR card and like techniques known in the art.

At second step, the authentication module (50) compares the photographs captured by the acquisition module (30) with the photographs fed/stored within the database during registration of the evaluator within the system (100). Specifically, the acquisition module (30) captures photograph of each evaluator of plurality of evaluator who are accessing the onscreen evaluation platform (150) from plurality of remote locations. The acquisition module (30) captures photographs of the evaluator at pre-defined time intervals (for ex. 10 sec, 20 sec, 30 sec) or at random time intervals. The authentication module (50) compares these photographs obtained at different time intervals with the photographs of the evaluator already registered and stored within the database module (40) to confirm the authenticity of the evaluator during evaluation and prevent other personnel from accessing the onscreen evaluation platform (150) in place of the registered evaluator, thereby maintaining integrity and quality of the evaluation. Specifically, when the evaluator tries to login within the onscreen evaluation platform (150), the system (100) intervenes and performs the authentication and authorization of the evaluator before providing access to the onscreen evaluation platform (150). In addition, the system (100) keeps a watch on the evaluator in real-time using the acquisition module (30) of the system (100), to verify if a single face is detected i.e. only one evaluator (personnel) is seen to be sitting in front of the computing device (10) who has been registered within the system (100), during the entire process of evaluation of the answer sheets. In the event, the system (100) detects more than one face, or no face at all, or detects some other evaluator whose credentials do not match with the registered credentials/photographs, the system (100) sends alerts to the administrator of the centralized web server (60), an event gets logged into the system and the access to the onscreen evaluation platform (150) gets interrupted.

For purpose of the present disclosure, the term “administrator” refers to any personnel who manages the centralized web server (60) and is provided with a remote access to the system (100) of the present invention configured on the centralized web server (60). Now, referring to FIG. 4, the administrator functions as a remote invigilator and is capable of remotely login in within the system (100) to view the plurality of evaluators and data related thereto stored in real-time within the database module (40) of the system. The administrator can keep a watch/monitor the plurality of evaluators or personnel who has been accessing the onscreen evaluation platform (150) remotely, using live streaming, and can also view historical video/images of the evaluator who has been using the system. In a non-limiting example embodiment, the administrator can evaluate/analyze system logs related to examiner geo tagging, audit logs, face recognition alerts and like activities performed while authentication and authorization of each evaluator of the plurality of evaluator prior to and while the onscreen evaluation activity is being performed. In the event the administrator comes across suspicious activity, live chat can be initiated remotely by the administrator with the evaluator involved in evaluation of the answer sheets while the evaluation process is ongoing. The administrator using the live chat feature can request the evaluator remotely during the onscreen evaluation activity to share information relating to, but not limiting thereto, identity credentials, identity card and like evidence that validates identity of the evaluator. In an embodiment, the live chat history gets logged and stored within the system for future reference. The administrator facilitates authentication of the evaluator along with the authentication module (50) of the system.

Referring to FIG. 3, scanning activity (120) is explained herewith. The copies of the answer sheets are scanned using the scanning apparatus. The scanning apparatus is configured with the scanning module (not shown) which checks whether all pages are scanned or not. The scanning module performs following functions, but not limited thereto:

1. To mask name, roll no of student and map a bar code to relevant record;

2. To assign page numbers for each page of the answer sheets.

3. To convert answer sheet into secured format like PDF file format; and

4. To upload the scanned answer sheets to Cloud Secure Storage (centralized database (70))

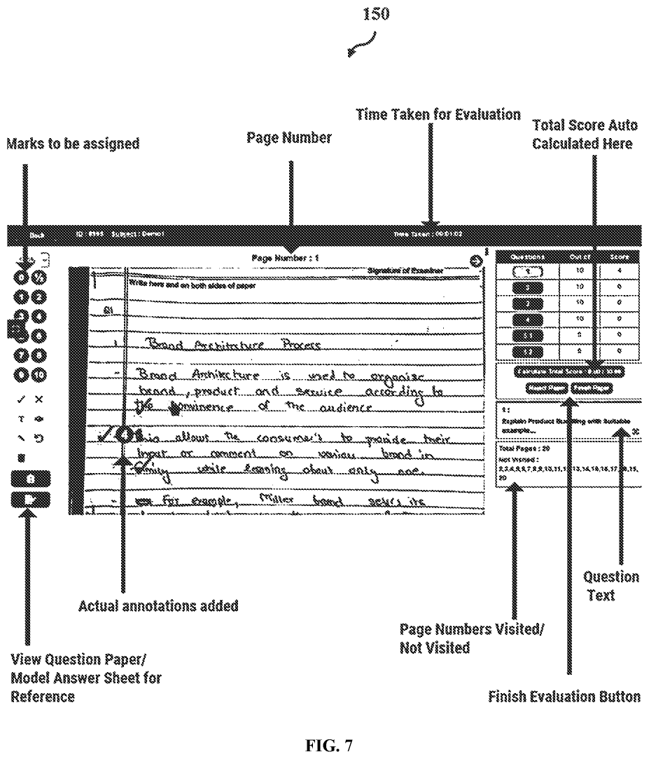

After the scanning activity (140), the system (100) assigns the scanned answer sheets to respective evaluators. In a preferred embodiment, the features of the onscreen evaluation platform (150) (Ref. FIG. 7) are described herewith. The onscreen evaluation platform (150) helps to convert physical answer sheet into digital format. The evaluator has been provided a control panel to open scanned answer sheet.

Along with scanned answer sheet the evaluator can access various functionalities as listed below:

A. Correct Sign: This sign is used to mark particular answer as correct by adding the symbol on the answer sheet.

B. Incorrect Sign: This sign is used to mark particular answer as incorrect by adding the symbol on the answer sheet.

C. Assign Marks for Answer: There are icons available for each number of marks which are used to define marks for particular answer. On single page, you can add partial marks and on next pages subsequent partial marks can be added. System would auto calculate total marks assigned for the answer;

D. Undo Operation: If you wish to undo particular activity then you can click on the icon to cancel previously performed task.

E. Add Comments: There is icon button available to add comments on any answer sheet page. You can click on it and define font to add comments.

F. Summary of Marks: On the right-hand top corner you can see marks allotted for each question. The system would automatically display the scores for each answer against question number as shown.

G. Question paper details: There is a link “View Question”. On clicking this button you can see Question contents. It can be helpful for you to see question contents before evaluating any answer.

H. On the right-hand bottom corner, total marks for the answer sheet are shown. System would auto calculate those marks based on examination pattern, optional questions etc.

I. In the end system would enable Finish Answer sheet checking button. It would be enabled only if examiner has navigated all the pages of the answer sheet. This ensures that complete answer sheet has been evaluated.

Further, the system (100) and the method (200) facilitate following features for easy evaluation of the answer sheets:

I. Handwriting Text Extraction:

Most of the times, it is quite difficult for the examiner to understand various types of handwriting and extract information from it and assign marks. The system is able to recognize handwritten text from answer sheet and it is shown in the form of summary to the examiner. The examiner would be able to easily see the answer shown in typed text and based on system recommendations examiner can assign marks for that particular answer. It would save lot of time for the examiner while evaluating the answer sheet.

II Comparison of Answer with Model Answer:

The system provides facility to compare answer typed by the student with model answer provided by the education institution (or university) for that specific question from question paper. The system compares keywords and answer written by the student. The system provides comparison summary of the written answer with model answer and recommendation. This recommendation would be useful for the examiner to assign marks for the answer. It would save lot of time for the examiner related to reading long text answer written by the student.

III. Auto Identification of Blank Answer Sheets:

Most of the times, it is mandatory for the examiner to scan all pages of the answer sheet/booklet. If student has kept some of the sheets as blank then read pen marking has to be done on the page to ensure that page has been evaluated. In case of onscreen evaluation system, it would automate blank page checking process. The system is able to identify blank pages from the booklet using pattern matching algorithm.

If student has written answers on only 6 pages out of 16 page booklet then system would automatically mark 11 blank pages. Examiners would only need to focus on 6 pages of written content for the evaluation process.

This activity involves machine learning and pattern analysis to detect and mark blank pages of the answer sheet. It would save time for the examiners for going through all blank pages of the answer sheet and add marking on each individual page of the answer sheet. It can save evaluation time significantly.

IV. Voice Based Evaluation

The system would have support for the voice based evaluation. Examiner would be connected to computer/laptop or tablet with microphone device.

Examiner can issue command to the system in following way.

Command Name: Move to Page No 1

Outcome: System would navigate to Page No 1 of answer sheet

Command Name: Select Question No 1 A

Outcome: System would select question No 1 A for evaluation

Command Name: Assign 2 Marks for Question No 1A on page No 1

Outcome: System would assign 2 marks for question No 1A on page no 1

Command Name: Assign wrong for Question No 1 A on Page No 1.

Outcome: System would mark question No 1A as wrong and zero marks on Page No

Command Name: Add comments “checked” on page No 5

Outcome: System would add comments on page No 5

Entire answer sheet evaluation can be completed using voice commands instead of manually using keyboard and mouse during evaluation process. It would save time of the evaluation and answer sheet checking can be completed in record time.

In the embodiment, the system (100) supports English language for the system recommendation for the above mentioned activities and later it can be supported for other languages.

Thus, the system (100) and the method (200) eliminate the need of the evaluator travelling to specific hub/exam center/central location for answer sheet evaluation/photocopying the answer sheets. The system (100) and the method (200) facilitate the evaluator to evaluate the answer sheets from a remote location. Thus, the system (100) and the method (200) eliminate barrier of location as the evaluator can access the onscreen evaluation platform (150) from any remote location (outside campus/institution). The system (100) and the method (200) by offering continuous monitoring (140) of the evaluator addresses concerns regarding fraudulent practices such as, not limiting to, assignment of the work to some other third party by the evaluator.

The system (100) and the method (200) when deployed during online examination prevent plurality of fraudulent activities performed by the candidates during examination such as, not limiting to, copying of answers and like. The system (100) and the method (200) thus address the data integrity and security along with evaluation quality concerns during onscreen evaluation activity (160). The system (100) and the method (200) by offering remote monitoring (140) of the evaluator during the onscreen evaluation activity saves administrative and logistical cost incurred by the evaluator for travelling to secure central location for evaluating the answer sheets. Even if the examiner is travelling or is based at different location, evaluation of the answer sheets can be managed using the onscreen evaluation platform (150) and can be remotely monitored using the system (100) and the method (200) of the present invention.

The system (100) and the method (200) are adapted to monitor and closely watch the evaluator even when the evaluator performs evaluation from, not limiting to, a public network or home, and sends alerts to the administrator in event of detection of suspicious activity (for ex. two faces detected, different evaluator detected compared to the registered evaluator). In addition, the system (100) and the method (200) facilitate the administrator to keep track of the progress of the evaluation activity for each evaluator of the plurality of evaluator differently located at remote locations thereby achieving evaluation within a certain timeframe.

The embodiments described herein above are non-limiting. The foregoing descriptive matter is to be interpreted merely as an illustration of the concept of the present disclosure and it is in no way to be construed as a limitation. Description of terminologies, concepts and processes known to persons acquainted with technology has been avoided to preclude beclouding of the afore-stated embodiments.

### Technical Advantages and Economic Significance

The technical advantages and economic significance of the system and the method of the present disclosure include but are not limited to:

1. Cost effective;

2. Real-time monitoring and control of the evaluator accessing the onscreen evaluation platform (150);

3. Security, data integrity and quality of evaluation is maintained; and

4. Evaluation activity can be completed in minimum timeframe.

1. A system for remote monitoring of an evaluator performing onscreen evaluation of answer sheets, the system comprising:
a computing device having,
at least one memory unit being capable of storing a plurality of processing instructions for an operation of the computing device,
at least one processor being capable of communicating with the memory unit, the processor configured to issue the plurality of processing instructions stored in the memory unit, and
at least one input-output device operably coupled thereto, the input-output device having:
a keyboard and a mouse for the evaluator to input a command/a message,
a microphone for acquiring voice of the evaluator,
a loudspeaker for outputting the voice,
a web camera for acquiring an image/a video of the evaluator,
a display unit for displaying the outcome of the imaging device;
a communication network adapted for communicating with the computing device;
a centralized web server adapted for processing the instructions received from the communication network, the centralized web server configured with a web application having an onscreen evaluation platform to evaluate the answer sheets, the onscreen evaluation platform being accessible on the computing device via the communication network for the evaluator, the web application comprising
at least one acquisition module configured to associate and control the web camera, the microphone and the loudspeaker of the computing device and adapted to continuously monitor the evaluator over the communication network by performing continuous activity of photo capturing, audio/video recording and streaming of the evaluator,
at least one database module adapted to store credentials of the evaluator initially registered on the onscreen evaluation platform and to maintain the captured photographs/images of the evaluator taken at different intervals of time by the acquisition module along with audio-video streaming of the evaluator;
at least one authentication module adapted to perform two step remote authentications including;
performing an identity check to validate the evaluator based on combination of parameters and techniques including One Time Password (OTP) authentication, face detection and identity card based authentication, and
comparing the photographs captured by the acquisition module with the photographs fed/stored within the database module during registration of the evaluator within the onscreen evaluation platform; and
a centralized database adapted for generating a corresponding output related to processed instructions received from the centralized web server and delivering the output to the computing device, wherein the centralized database stores scanned copies of the answer sheets.

2. The system as claimed in claim 1, further comprising a scanning apparatus to scan copies of the answer sheets.

3. The system as claimed in claim 1, wherein the onscreen evaluation platform provides a control panel to the evaluator to open a scanned copy of the answer sheet for performing the evaluation using annotation tools.

4. The system as claimed in claim 1, wherein the acquisition module further activates and initiates video streaming of the evaluator.

5. The system as claimed in claim 1, wherein the acquisition module is further adapted to generate geotags for the photographs acquired using the web camera.

6. The system as claimed in claim 1, wherein, on remotely accessing the onscreen evaluation platform using login credentials by the evaluator, the system intervenes to validate the identity/credentials of the evaluator and to verify if the computing device used by the evaluator satisfies certain pre-set hardware configuration requirements before allowing communication and access to the onscreen evaluation platform.

7. The system as claimed in claim 1, wherein the onscreen evaluation platform is further adapted to automatically calculate total scoring based on the evaluation performed by the evaluator and maintain activity logs of the evaluator.

8. The system as claimed in claim 1, wherein the computing device is selected from a computer, a laptop, a desktop, a smartphone, a mobile, a cell phone, a Personal Digital Assistant (PDA), and a tablet.

9. The system as claimed in claim 1, wherein the communication network is any one of a wired and a wireless communication network selected from local area network, wide area networks, Bluetooth network, or aggregated networks.

10. A method for remote monitoring of an evaluator performing onscreen evaluation of answer sheets, the answer sheets being scanned and assigned to the evaluator, the method comprising the steps of:
logging by the evaluator using credentials to remotely access an onscreen evaluation platform configured on a computing device to evaluate answer sheets online from a remote location;
intervening and performing authentication and authorization of the evaluator by the authentication module;
checking pre-set hardware configuration requirements of the computing device;
providing access to the onscreen evaluation platform for the evaluator to evaluate assigned answer sheets;
continuously monitoring the evaluator over a communication network by performing continuous activity of photo capturing, audio/video recording and streaming of the evaluator; and
maintaining activity logs, the captured photographs/images of the evaluator taken at different intervals of time by the acquisition module along with audio-video streaming of the evaluator.

11. The method as claimed in claim 10, wherein the step of authentication and authorization of the evaluator further involves:
performing an identity check to validate the evaluator based on a combination of parameters and techniques including One Time Password (OTP) authentication, face detection and identity card based authentication,
comparing the photographs captured by the acquisition module with the photographs fed/stored within the database module during registration of the evaluator within the onscreen evaluation platform, and
tagging with geographical information of the evaluator.

12. The method as claimed in claim 10, wherein the step of continuously monitoring the evaluator further involves:
watching on the evaluator in real-time using the acquisition module of the system,
verifying a single face detection of the registered evaluator during entire process of evaluation of the answer sheets, and
sending alerts to an administrator of the centralized web server in the event of detecting more than one face, no face at all, or detecting some other evaluator whose credentials do not match the registered credentials/photographs.

13. The method as claimed in claim 10, wherein the step of accessing the onscreen evaluation platform further comprises:
providing a control panel to the evaluator to open scanned copy of the answer sheet for performing the evaluation using annotation tools,
auto identifying blank pages using image processing and skipping the blank pages for evaluation,
showing handwriting in simple text for quick understanding of the answers of the evaluator,
auto comparing answers with model answers for system recommendation for answer quality,
accepting voice commands for evaluation,
auto checking of evaluation of all pages of the answer sheet,
enabling finish evaluation to proceed for next answer sheet evaluation, and
auto calculating total score/marks based on question paper pattern.

14. The method as claimed in claim 10, further comprising recording entire evaluation activity of the evaluator for auditing purposes.
